(19) United States
(12) Patent Application Publication
(10) Pub. No.: US 2024/0330956 A1
(43) Pub. Date: Oct. 3, 2024

(54) SYSTEM AND METHOD FOR ELECTRONIC SIGNATURE WITH A COUNTRY SPECIFIC CERTIFICATION SERVICE SELECTION

(71) Applicant: Certinal Software Private Limited, Mumbai (IN)

(72) Inventors: Krishnendu Chattopadhyaya, Mumbai (IN); Abhishek Kumar, Mumbai (IN)

(73) Assignee: Certinal Software Private Limited, Mumbai (IN)

(21) Appl. No.: 18/620,546

(22) Filed: Mar. 28, 2024

(30) Foreign Application Priority Data
Mar. 29, 2023 (IN) 202321022986

(51) Int. Cl. G06Q 30/018

(52) U.S. Cl. CPC G06Q 30/018

(57) ABSTRACT

A system (1) and method for electronic signature, comprising an electronic signature solution (3) having a country specific certification service selection feature (8) which allows the sender (6) of the document (7) to select a country specific certification service on the fly, and wherein administrator user (5) has the right to enable and/or disable the country specific certification service selection feature (8) for senders (6), and can also restrict access and usage to the feature to specific roles in a tenant organization (2), if enabled, the feature (8) can be accessed and used by the senders thereby allowing them to select a country specific certification service (18) and subsequently download a country specific compliance certificate (19), and wherein the system (1) and method ensure that the selected certification service electronic signature norms are adhered to during the electronic signature process.

### CROSS-REFERENCE TO RELATED APPLICATION

The instant application claims priority to Indian patent application Ser. No. 20/232,1022986, filed Mar. 29, 2023, the entire specification of which is expressly incorporated herein by reference.

### FIELD OF THE INVENTION

The present invention relates to electronic signatures systems and methods. Particularly the present invention relates to a system and method for electronic signature comprising of country specific certification service provider selection feature which allows the sender of a document to select a country specific certification service provider on the fly.

### BACKGROUND OF THE INVENTION

Electronic documents form an integral part of today's business world. In a business scenario, these electronic documents can be crucial documents such as agreements, contracts, tax documents, legal documents to name a few. Such documents typically require a number of people to sign them in order to be validated.

Traditionally, such important business documents were shared and exchanged between all the signatories involved in the document in order for them to sign the documents physically. This made the document exchange and signing a very cumbersome and time consuming process. In order to overcome this problem, the concept of electronic signatures was introduced a few years back. Electronic signatures make the electronic document signing process very user friendly, secure, convenient, easily accessible and less time consuming.

A few electronic signature platforms have emerged in the past few years which facilitate the process of electronic signing of the electronic documents. However, these platforms have their own limitations. A crucial requirement in the electronic signature process is the issuance of a digital signature certificate. The trusted agencies or service providers who are granted the license by the government to issue, revoke, renew and provide directories for digital signature certificates for the purpose of electronic signatures are known as Certifying Authorities (CAs) or Certification Service Provider (CSPs).

In many countries, certification services are essential components of ensuring that products and services meet specific standards and regulations. These certification services are usually accredited by the government and comply with various local and global regulations. This ensures that the products and services meet the required standards and regulations for safety, quality and environmental protection. Certification services serve multiple functions. One of these main functions is establishing trust between two parties for given transactions and ensuring legal validity of signed documents between them. This can be achieved by digital stamping on electronically signed documents.

Electronically signed documents need a digital stamp from a Certification Service Provider (CSP) to have legal validity. The digital stamp acts as a proof of authenticity, integration, and non-repudiation of the electronically signed document. Certain geographical regions/countries have a mandate that electronic documents must be digitally stamped. A certification service is used for this digital stamping. The digital stamping is done after the electronic signing of the documents. Every country has a specific set of certification services and providers/authorities which comply with the country specific legal requirements.

However, the electronic signature platforms currently available in the market have certain limitation with respect to facilitation of country specific certification services to the users. These platforms do not have the functionality to enable the user to select different country specific certification on the user interface and on the fly. If the user wants to have any country specific certification to be used he/she has to provide request offline to the electronic signature application provider, the provider needs to build up that feature from back-end and then enable that country specific feature for the user. Further, such country specific service is enabled for only one country specific service provider. Next time if the user needs any other country specific service provider again it needs to be build up from back-end and the user does not have an option to see multiple certificate service providers and select one from them on the user interface on the fly.

### PRIOR ART

US Patent Publication No. 20160239471 describes a system, computer-readable storage medium, and computer-implemented method for improved document signing involving generating secure document copies of a document to be signed in response to receiving actions to perform on the document. In particular, a web service can transmit a document for signing to a plurality of client devices such that the document is viewable through a graphical user interface while the underlying content of the document remains non-editable. Responsive to receiving actions from different client devices, secure document copies of the document can be generated that include additional content form the different client devices. However, the patent is completely silent about any kind of feature that provides for country specific certificate service selection to the sender of the document. This is a major drawback, as in today's global economy, electronic documents are shared across multiple and the electronic signature process has to comply with the country specific requirements which are mandated by them. US Patent Publication No. 20160239471 fails to address this issue altogether.

Hence, there is a need for a system and method which could overcome the above limitations of the existing electronic signature platforms available in the market.

### OBJECTS OF THE INVENTION

An object of the present invention is to provide a system and method for electronic signatures comprising of an electronic signature solution with a country specific certification service selection feature.

Another object of the present invention is to provide a system and method for electronic signatures comprising of an electronic signature solution with a country specific certification service selection feature, which allows the user to select a country specific certification service on the fly.

Yet another object of the present invention is to provide a system and method for electronic signatures comprising of an electronic signature solution with a country specific certification service selection feature, which ensures that the selected certification service electronic signature norms are adhered to during the electronic signature process.

Yet another object of the present invention is to provide a system and method for electronic signatures comprising of an electronic signature solution with a country specific certification service selection feature, which allows the user to select from multiple certification service providers.

Yet another object of the present invention is to provide a system and method for electronic signatures comprising of an electronic signature solution with a country specific certification service selection feature, which vests the enabling and disabling rights in the administrator user of the tenant organization so as to ensure that only authorized people have access to the feature and can avail it accordingly.

Yet another object of the present invention is to provide a system and method for electronic signatures comprising of an electronic signature solution with a country specific certification service selection feature, which allows the administrator user to restrict the usage of the enabled certification service to specific sender role(s).

Yet another object of the present invention is to provide a system and method for electronic signatures comprising of an electronic signature solution with a country specific certification service selection feature, which allows the user to download the country specific compliance certificate after the completion of the electronic signature process.

### SUMMARY OF THE INVENTION

The present invention relates to a system and method for electronic signature comprising of an electronic signature solution with a country specific certification service selection feature. The country specific certification service selection feature allows the sender of a document to select a country specific certification service provider on the fly.

In one aspect, the system of the present invention comprises of a tenant organization, document(s) to be electronically signed, sender of the document, computing system consisting of a memory unit, a processing means, plurality of databases, input device, output device, a network connection means, and an electronic signature solution further comprising of the country specific certification service selection feature.

In another aspect, the country specific certification service selection feature comprises of a selection engine and allows the sender of the document to select country specific certification service on the fly, from a list of available certification services. The system also allows the administrator user of a tenant organization to enable and/or disable the feature for access and use of senders of the documents in the tenant organization.

In yet another aspect, the administrator user can restrict the access and usage of the country specific certification service selection feature to specific role(s) in the tenant organization. This ensures that only authorized personnel in the organization are able to access and use the feature. Further, the senders are also allowed to download the country specific compliance certificate issued by the certification authorities.

In yet another aspect, the method of the present invention involves the steps of accessing the electronic signature solution, accessing the country specific certification service selection feature, selecting certification services option on it, selecting the required country specific certification service, enabling the feature for other senders, restricting access to specific role(s) if needed, sending the document to recipients, and downloading the certificate of compliance.

### BRIEF DESCRIPTION OF THE DRAWINGS

FIG. 1 illustrates a schematic view of the system and method of the present invention being implemented in a tenant organization.

FIG. 2 illustrates a schematic view of the computing system of a user of the system and method of the present invention.

FIG. 3 illustrates a schematic view of the electronic signature process of a document which is marked for a country specific certification service.

### DETAILED DESCRIPTION OF THE INVENTION

Before the present invention is described, it is to be understood that this invention is not limited to methodologies described, as these may vary as per the person skilled in the art. It is also to be understood that the terminology used in the description is for the purpose of describing the particular embodiments only and is not intended to limit the scope of the present invention. Throughout this specification, the word “comprise,” or variations such as “comprises” or “comprising,” will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

The present invention relates to electronic signature systems and methods. Particularly the present invention relates to a system and method for electronic signature comprising of an electronic signature solution with a country specific certification service selection feature which allows the user to select a country specific certification service provider on the fly.

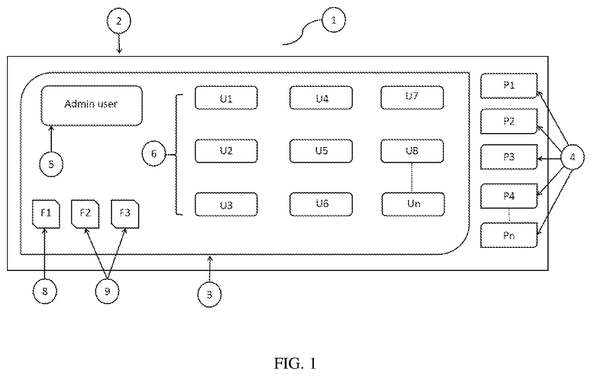

In a preferred embodiment, the system (1) for electronic signature is typically used at an organizational level and the organization which is using the system (1) is referred to as the tenant organization (2). The scheme of operation of the system (1) is as illustrated in FIG. 1. The tenant organization (2) makes use of the electronic signature solution (3) of the present invention for managing electronic signature processes along with other platforms/solutions (4) for several other purposes depicted as P1, P2, P3, P4, . . . , Pn in FIG. 1. The electronic signature solution (3) can be accessed and used by the administrator user (5) as well as other users who are senders (6) of the document(s) (7) which are to be electronically signed. These users (6) are depicted as U1, U2, U3, U4, U5, U6, U7, U8, . . . , Un. However, the administrator user (5) has certain exclusive rights with respect to the operation of the electronic signature solution (3). It is to be noted that while the present description includes a single administrator user (5) for explanatory and simplicity purposes, the actual system may involve multiple administrator user (5) who have similar rights as mentioned above.

In a preferred embodiment, the electronic signature solution (3) comprises of a country specific certification service selection feature (8) along with other features (9) depicted as F2 and F3. It is to be noted that the electronic signature solution (3) can have any number of features and F1, F2, F3 are depicted only for simplicity and clarity purposes.

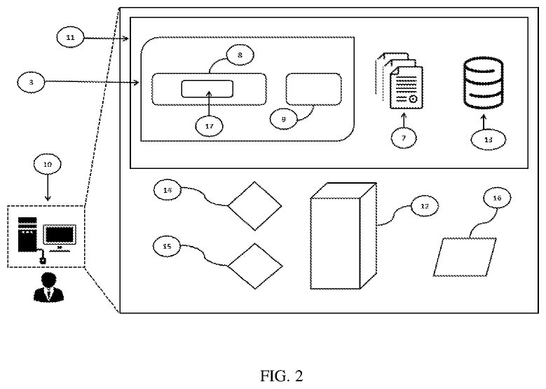

In an embodiment, the administrator user (5) as well as senders (6) of the electronic signature solution (3) can access the solution (3) by means of their respective computing systems (10). Each computing system (10) comprises of a memory unit (11) capable of storing instructions which when followed lead to performance of certain computational steps, a processing means (12), plurality of databases (13), input devices (14), output devices (15), and a network connection means (16) capable of connecting to a communication network. The computing system (10) is as illustrated in FIG. 2. In an embodiment, a hosting server stores the contracts/documents (7).

In an embodiment, administrator user (5) can enable or disable country specific certification service (8) of the electronic signature solution (3). The rights of enabling and disabling lie exclusively with the administrator user (5). Once enabled, the country specific certification service selection feature (8) can be used by the senders (6). Likewise, if disabled, the feature cannot be used by the user (6). This ensures that the access to use this important feature is given only to authorized personnel of the tenant organization (2).

In an embodiment, when the country specific certification service selection feature (8) is enabled, the user (6) can opt for this feature and consequently a list of country specific certification services subscribed and configured with the electronic signature solution (3) is displayed to the sender (6). The sender (6) can then select a specific certification service as per the requirements. For example, as per the laws of Mexico, the electronically signed document needs to be digitally stamped as per NOM-151. In this case, if the NOM-151 certification service is configured with the electronic signature solution (3), the country specific certification service selection feature (8) enables the user to view it and select it for the required document (7). The selection of a particular country specific certification service by the sender (6) ensures that the electronic signature norms as defined for the respective certification service are followed in the transaction.

In another embodiment, the administrator user (5) is authorized to restrict access of the country specific certification service selection feature (8) to specific role(s). Initially, all the roles within an organization are presented to the administrator user (5) for selection. The administrator user (5) can select the specific roles to which he/she intends to grant access to the country specific certification service selection feature (8).

Accounting, custom procurement, legal are some of the examples of such roles. The restriction of access to the feature ensures that only authorized personnel from the tenant organization (2) get access to and can use the country specific certification service selection feature (8).

In another embodiment, when a sender (6), who is the sender of a document (7) has access to the country specific certification service selection feature (8), he/she can send the document (7) for electronic signature selecting one of the country specific certification service options available using the country specific certification service selection feature (8) followed by other steps involved in the electronic signature process of the electronic signature solution (3).

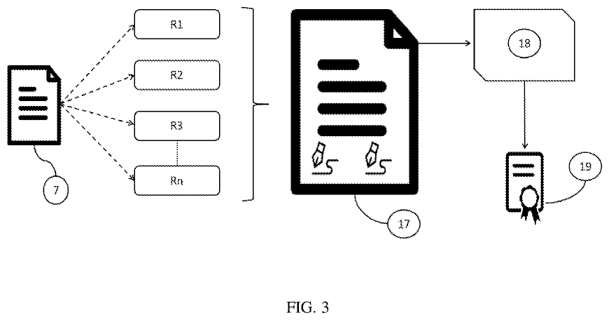

In an embodiment, a document (7) marked for a specific certification service is first sent to all the available recipients as per the order set by the sender for document signing. Once signed by all the intended recipients, depicted as R1, R2, R3, . . . , Rn in FIG. 3, the signed document (17) is sent to the certification service provider (18) for issuing a compliance certificate (19). The compliance certificate (19) is with reference to the completed transaction from user/sender selected authorized certification service provider. After the entire process is completed, the sender (6) can download the country specific compliance certificate (19) along with other documents.

The present invention further relates to a method for electronic signature involving an electronic signature solution (3) with the country specific certification service selection feature (8). The method not only allows the administrator user (5) to select, enable and/or disable the country specific certification services of the electronic signature solution (3), but also allows him/her to restrict the access to country specific certification to specific or limited role(s) in the tenant organization (2). This ensures that only the authorized personnel in the tenant organization (2) get to access and use the feature.

In a preferred implementation, the method for electronic signature involving an electronic signature solution (3) with the country specific certification service selection feature (8) includes the following steps:
a. accessing the electronic signature solution (3) by the administrator user (5) by means of its graphical user interface;
b. accessing the country specific certification service selection feature (8) settings available on the graphical user interface of the electronic signature solution (3) by the administrator user (5);
c. selecting the certification services option;
d. selecting the required country specific certification service (18) from the list of all the available subscribed country specific certification services configured with the electronic signature solution (3);
e. enabling the required country specific certification service;
f. providing a connector service web-hook URL for the enabled country specific certification service (18);
g. saving the configurations made and completing the enablement process of the required certification service (18) for access to the other sender (6) of the tenant organization (2).
h. optionally, if required, performing the following steps if the access to the enabled certification service (18) is to be restricted to specific role(s) in the tenant organization (2);
   i. selection of specific role(s) to whom the access of the enabled certification service (18) is to be given;
   ii. saving the configurations made so as to restrict the usage;
i. accessing the country specific certification service selection feature (8) by the sender (6) via the graphical user interface of the electronic signature solution (3);
j. selecting the required country specific certification service (18) for a particular document (7) to be signed;
k. sending the document (7) marked for the country specific certification service (18) to the available recipients for signatures;
l. downloading a certificate of compliance (19) on completion of the electronic signature process.

In an alternate embodiment, instead of manual selection of the country specific certification service (18) by the sender (6), the selection is done in an intelligent manner. This selection is based on system intelligence which includes analysis of metadata fields on the graphical user interface of the electronic signature solution (3). This can be explained by way of an example. For instance, a metadata field “region” can be inserted on the graphical user interface. Now, if Norway is the region which is entered under the “region” metadata field, the system automatically suggests the sender (6) to go for a certification service (18) provider of Norway since it is a mandate in Norway to have an electronically signed document stamped. This alternate embodiment feature is significant as each country across the globe does not have a mandate for stamping by certification service providers. Such mandate exists only in certain countries. The sender (6) of the document (7) may not always be aware of the legal requirements or regional laws of each country with respect to the compliance of the electronic signatures. Hence, in such scenarios the system of the present invention helps the sender to a great extent.

The advantages of the system and method of the present invention are multi-fold. Firstly, the system and method of the present allow a user to select a country specific certification service on the fly unlike the prior arts which necessitate the processing of such a request at the backend and not on the fly. Secondly, the system and method also allow the enabling and dis-enabling of country specific certification service by the administrator user. Moreover, the administrator user can also restrict the usage of the country specific certification service selection feature to specific role(s) in the tenant organization. This ensures that the country specific certification service can be used only by authorized personnel in the tenant organization. Furthermore, it also allows the administrator user to create custom roles of his/her choice.

While considerable emphasis has been placed herein on the specific elements of the preferred embodiment, it will be appreciated that many alterations can be made and that many modifications can be made in preferred embodiment without departing from the principles of the invention. These and other changes in the preferred embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A system for electronic signature, including a tenant organization, at least one document to be electronically signed, at least one sender of the document, at least one computing system consisting of a memory unit, a processing means, plurality of databases, at least one input device, at least one output device, and a network connection means, comprising:
an electronic signature solution including a country specific certification service selection feature, at least one administrator user, at least one sender of the document to be electronically signed, and a graphical user interface;
wherein the country specific certification service selection feature further comprises of a selection engine;
wherein the country specific certification service selection feature allows the administrator user to enable or disable a country specific certification service for the document and restrict the access and usage of the feature to specific roles in the tenant organization;
wherein the country specific certification service selection feature once enabled by the administrator user, allows the sender to select a country specific certification service on the fly by means of the selection engine from the list of available and subscribed certification services enabled by the administrator user;
wherein the document marked for a country specific service is sent to all recipients for signing;
wherein the electronically signed document is sent to the selected certification service for issuing a compliance certificate; and
wherein the country specific certification service selection feature allows the sender to download the country specific compliance certificate.

2. The system as claimed in claim 1, wherein the country specific certification service feature is accessed via the graphical user interface of the electronic signature solution.

3. The system as claimed in claim 1, wherein the specific roles in the tenant organization are configurable and customizable by the administrator user.

4. The system as claimed in claim 1, wherein the selection of a country specific certification service by the sender is done either manually by the sender or based on an intelligent suggestion provided by the system.

5. A method for electronic signature of documents including an electronic signature solution with a country specific certification service selection feature, comprising the steps of:
a. accessing an electronic signature solution by an administrator user, by means of a graphical user interface;
b. accessing the country specific certification service selection feature settings available on the graphical user interface of the electronic signature solution by the administrator user;
c. selecting certification services option;
d. selecting required country specific certification service from a list of all the available subscribed country specific certification services configured with the electronic signature solution;
e. enabling the required country specific certification service;
f. providing a connector service web-hook URL for the enabled country specific certification service;
g. saving the configurations so made and completing the enablement process of the required certification service for allowing access to senders of the tenant organization;
h. optionally, performing the following steps if the access to the enabled certification service is to be restricted to specific roles in the tenant organization:
i. selection of specific roles to whom the access of the enabled certification service is to be given; or
ii. saving the configurations made so as to restrict the usage;
i. accessing the country specific certification service selection feature by the sender via the graphical user interface of the electronic signature solution;
j. selecting the required country specific certification service for a particular document to be signed by means of a selection engine;
k. sending the document marked for the country specific certification service to available recipients for signatures; and
l. downloading a certificate of compliance on completion of the electronic signature process.

6. The method as claimed in claim 5, wherein the method is implemented on a computing system.

7. The method as claimed in claim 5, selection of step j is done either manually by the sender or based on an intelligent suggestion provided by the system.
